(19) United States
(12) Patent Application Publication
(10) Pub. No.: US 2025/0038296 A1
(43) Pub. Date: Jan. 30, 2025

(54) PROTECTION METHOD FOR BATTERY PACK, AND PROTECTION DEVICE AND BATTERY PACK PERFORMING THE SAME

(71) Applicant: SAMSUNG SDI CO., LTD., Yongin-si (KR)

(72) Inventors: Jong Sam PARK, Yongin-si (KR); Hyomin KIM, Yongin-si (KR)

(21) Appl. No.: 18/441,336

(22) Filed: Feb. 14, 2024

(30) Foreign Application Priority Data
Jul. 27, 2023 (KR) 10-2023-0098390

(51) Int. Cl. H01M 10/633; H01M 10/48; H02J 7/00

(52) U.S. Cl. CPC H01M 10/633; H01M 10/486; H02J 7/00309; H02J 7/007194

(57) ABSTRACT

A protection device for a battery pack including a battery includes: a temperature sensor configured to measure a temperature of the battery module; and a control device configured to perform a protection operation of the battery pack if a first temperature value measured through the temperature sensor during a use of the battery module is greater than a first temperature limit value and to correct the first temperature limit value according to a second temperature value measured through the temperature sensor after the protection operation is performed.

### CROSS-REFERENCE TO RELATED APPLICATION

This application claims priority to and the benefit of Korean Patent Application No. 10-2023-0098390 filed at the Korean Intellectual Property Office on Jul. 27, 2023, the entire contents of which are incorporated herein by reference.

### BACKGROUND

### 1. Field

The present disclosure relates to a protection method for a battery pack, and a protection device and a battery pack that perform the same.

### 2. Description of the Related Art

A secondary battery that may be repeatedly charged and discharged differs from a primary battery that provides only irreversible conversion of chemical energy to electrical energy. A low-capacity secondary battery is used as a power supply for a small electronic device such as a mobile phone, a laptop computer, or a camcorder, and a high-capacity secondary battery is used as a power supply for a hybrid vehicle or the like.

In general, a secondary battery cell includes an electrode assembly including a positive electrode, a negative electrode, and a separator interposed between the positive electrode and the negative electrode, a case accommodating the electrode assembly, and an electrode terminal electrically connected to the electrode assembly. An electrolyte solution is injected into the case to enable charging and discharging of the battery cell through an electrochemical reaction between the positive electrode, the negative electrode, and the electrolyte solution. A shape of the case such as a cylindrical or rectangular shape varies depending on a use of the battery cell.

Battery cells may be connected in series and/or in parallel to form a battery module with high energy density. A battery pack may include one or more of battery modules according to a required specification.

In the battery pack, an overheating phenomenon in which the battery cell is overheated may occur due to a short circuit, a disconnection, an overcurrent, an overvoltage, a high temperature environment, or the like.

A protection circuit protects the battery pack by performing a protection action such as stopping charging and discharging or the like if a temperature value of the battery cell is higher than a predetermined temperature limit value. Typically, the temperature limit value is set in advance when the battery pack is released, and battery packs with the same specification are set to have the same temperature limit value.

Even after the protection operation is performed, a phenomenon in which a temperature of the battery cell continues to rise for a predetermined period of time due to residual heat, occurs.

The residual heat after the protection operation is performed in the battery pack varies depending on an output of the battery pack at a time when the protection operation is performed. A degree of temperature rise of the battery cell after the protection operation may vary depending on the output of the battery pack at the time when the protection operation is performed.

If the battery pack is mounted on an electronic device (e.g., a cleaner) whose output is adjusted in multiple stages, the output of the battery pack varies depending on an output of the mounted electronic device. If the battery pack is used in common, the output of the battery pack varies depending on the output of the electronic device on which the battery pack is mounted. However, an existing protection circuit performs a protection operation using a fixed temperature limit value so that there is a problem in which it is difficult to appropriately respond if the output of the battery pack changes.

### SUMMARY

Embodiments are directed to, in a first aspect, a protection device for a battery pack including a battery module, including: a temperature sensor that may be configured to measure a temperature of the battery module; and a controller (e.g., a controller) that may be configured to perform a protection operation of the battery pack if a first temperature value measured through the temperature sensor during a use of the battery module is greater than a first temperature limit value and to correct the first temperature limit value according to a second temperature value measured through the temperature sensor after the protection operation is performed.

The protection device of the first aspect may, further include a storage device that may be configured to store at least one temperature limit value corresponding to at least one output value of the battery pack. The protection device of the first aspect, wherein the controller may be further configured to select the first temperature limit value according to the output value of the battery pack. The protection device of the first aspect, wherein if the battery pack outputs a first output value and the temperature limit value corresponding to the first output value is already stored in the storage device, the controller may be further configured to use the temperature limit value corresponding to the first output value as the first temperature limit value. The protection device of the first aspect, wherein if the battery pack outputs a second output value that is different from the first output value and the temperature limit value corresponding to the second output value is already stored in the storage device, the controller may be further configured to use the temperature limit value corresponding to the second output value as the first temperature limit value. The protection device of the first aspect, wherein if the battery pack outputs a third output value and the temperature limit value corresponding to the third output value is not stored in the storage device, the controller may be further configured to use a predetermined default value as the first temperature limit value.

The protection device of the first aspect, wherein if the second temperature value is greater than a maximum allowable temperature value, the controller may be further configured to correct the first temperature limit value to be reduced by a predetermined value.

The protection device of the first aspect, wherein if the second temperature value is less than or equal to a maximum allowable temperature value, the controller may be further configured to maintain the first temperature limit value.

The protection device of the first aspect, wherein if the protection operation is performed while the battery pack discharges to a first output value and a temperature limit value corresponding to the first output value is not stored in the storage device, the controller may be further configured to store the first temperature limit value in the storage device as the temperature limit value corresponding to the first output value.

Embodiments are directed to, in a second aspect, a battery pack including: a battery module; and a protection device for a battery pack including a battery module. The battery pack may include: a temperature sensor may be configured to measure a temperature of the battery module; and a controller may be configured to perform a protection operation of the battery pack if a first temperature value measured through the temperature sensor during a use of the battery module is greater than a first temperature limit value and to correct the first temperature limit value according to a second temperature value measured through the temperature sensor after the protection operation is performed.

Embodiments are directed to, in a third aspect, a protection method of for a battery pack, including: measuring a first temperature value of a battery module included in the battery pack while the battery pack discharges; performing a protection operation of the battery pack if the first temperature value is greater than a first temperature limit value; measuring a second temperature value of the battery module after the protection operation is performed; and correcting the first temperature limit value according to the second temperature value.

The protection method of the third aspect, further including selecting the first temperature limit value according to an output value of the battery pack. The protection method of the third aspect, wherein the selecting of the first temperature limit value may include selecting an already stored temperature limit value corresponding to a first output value as the first temperature limit value if the battery pack outputs the first output value and a temperature limit value corresponding to the first output value is already stored. The protection method of the third aspect, wherein the selecting of the first temperature limit value may include selecting an already stored temperature limit value corresponding to a second output value as the first temperature limit value if the battery pack outputs the second output value different from the first output value and a temperature limit value corresponding to the second output value is already stored. The protection method as claimed in claim 13, wherein the selecting of the first temperature limit value includes selecting a default value as the first temperature limit value if the battery pack outputs a third output value and a temperature limit value corresponding to the third output value is not stored.

The protection method of the third aspect, wherein the correcting of the first temperature limit value may include correcting the first temperature limit value to be reduced by a predetermined value if the second temperature value is greater than a maximum allowable temperature value.

The protection method of the third aspect, wherein the correcting of the first temperature limit value may include maintaining the first temperature limit value if the second temperature value is less than or equal to a maximum allowable temperature value.

The protection method of the third aspect, further including registering the first temperature limit value as a temperature limit value corresponding to a first output value if the protection operation is performed while the battery pack discharges to the first output value and the temperature limit value corresponding to the first output value is not registered.

### BRIEF DESCRIPTION OF THE DRAWINGS

Features will become apparent to those of skill in the art by describing in detail exemplary embodiments with reference to the attached drawings in which:

FIG. 1 schematically shows a battery pack according to one or more embodiments.

FIG. 2 is a flow diagram for a protection method of the battery pack according to one or more embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Embodiments of the present disclosure will now be described in detail with accompanying drawings. Operation effects of the embodiments of the present disclosure, and a realization method thereof will now be described with accompanying drawings. In the drawings, the same reference numerals indicate the same constituent elements, and no repeated descriptions thereof will be provided. As those skilled in the art would realize, the described embodiments may be modified in various different ways, all without departing from the spirit or scope of the present disclosure. The embodiments are provided as examples so that the present disclosure may be thorough and complete, and will sufficiently supply aspects and characteristics of the present disclosure to a person skilled in the art.

Hence, for the purpose of complete understanding on the aspects and the characteristics of the present disclosure, processes, factors, and skills that may not be needed by a person of ordinary skill in the art may not be described. In the drawings, relative sizes of elements, layers, and regions may be exaggerated for clarity.

In the present specification, the term “and/or” includes any and all combinations of the associated listed items. When the embodiments of the present disclosure are described, the use of “can” or “may” signifies at least one embodiment of the present disclosure. In the following description of the embodiments of the present disclosure, a singular term may include a plural form unless stated in another way.

In the present specification, terms including ordinal numbers such as first, second, and third will be used only to describe various constituent elements, and are not to be interpreted as limiting these constituent elements. The terms are only used to differentiate one constituent element from other constituent elements. For example, a first constituent element could be termed a second constituent element, and similarly, a second constituent element could be termed a first constituent element, without departing from the scope of the present disclosure. An expression such as “at least one” precedes a list of constituent elements to modify an entire list of constituent elements and not to modify an individual constituent element of the list.

In the present specification, the terms “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/−5% of the value centered on the value.

It will be understood that when a constituent element or layer is referred to as being “on,” “connected to,” or “coupled to” another constituent element or layer, it may be directly on, connected to, or coupled to the other constituent element or layer, or one or more intervening constituent elements or layers may be present. It will also be understood that when a constituent element or layer is referred to as being “between” two constituent elements or layers, it may be the only constituent element or layer between the two constituent elements or layers, or one or more intervening constituent elements or layers may also be present.

Electrically connecting two constituent elements may include directly connecting two constituent elements, and connecting the same with another constituent element therebetween. The other constituent element may include a switch, a resistor, a capacitor, or the like. When the embodiments are described, an expression of connection signifies electrical connection when an expression of direct connection is not provided.

Hereinafter, a protection device according to embodiments and a battery pack including the same will be described in detail with reference to necessary drawings.

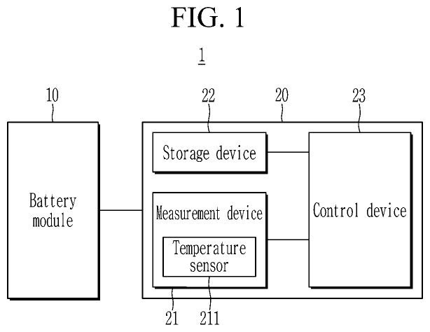

FIG. 1 schematically shows the battery pack according to an embodiment.

Referring to FIG. 1, the battery pack 1 may include, for example, a battery module 10 and the protection device 20.

The battery module 10 may include a plurality of battery cells connected in series and/or in parallel between pack terminals.

The protection device 20 may include, for example, a measurement device 21, a storage device 22, and a control device 23.

The measurement device 21 may measure a state (e.g., a voltage, a current, a temperature, or the like) of the battery module 10. For example, the measurement device 21 may include a temperature sensor 211 for measuring a temperature of the battery module 10.

The storage device 22 may include at least one memory, and may store various information, data, and the like processed by the protection device 20. The storage device 22 may temporarily store measurement data measured by the measurement device 21. The storage device 22 may store various protection values (e.g., a voltage limit value, a current limit value, a temperature limit value, and the like) that serve as a reference (or a reference value) for performing a protection function.

The storage device 22 may store the temperature limit value that varies according to an output of the battery pack 1. For example, the storage device 22 may divide the output of the battery pack 1 into a plurality of sections (or a plurality of values), and may store the temperature limit value corresponding to each section (or each value). Table 1 below shows an example of the temperature limit value stored in the storage device 22.

TABLE 1

| Battery pack output (W) | Temperature limit value (° C.) |
|---|---|
| 2000 | 65 |
| 1800 | 67 |
| 1000 | 70 |

The storage device 22 may store temperature limit values in a table form as shown in Table 1. The storage device 22 may store a maximum allowable temperature value of the battery module 10. The maximum allowable temperature value may be different from the temperature limit value, and may be a reference value for evaluating a temperature increase of the battery module 10 due to residual heat after a protection operation. The temperature limit value may be an appropriate value so that the battery cell is not damaged even if the temperature of the battery cell rises due to the residual heat. A degree of temperature rise of the battery cell after the protection operation may vary depending on the output of the battery pack at the time when the protection operation is performed. The maximum allowable temperature value may be set to a value greater than the temperature limit value, and may be determined by a cell characteristic of the battery module 10.

The control device 23 may receive the measurement data (e.g., a voltage, a current, a temperature, and the like) from the measurement device 21, and may monitor the state of the battery module 10 based on the measurement data. The control device 23 may perform a cell balancing function, a charging and discharging control function, the protection function, and the like depending on the state of the battery module 10.

If a temperature value of the battery module 10 measured through the measurement device 21 during use (e.g., discharging) of the battery module 10 is higher than the temperature limit value, the control device 23 may perform a protection operation that blocks charging and discharging of the battery module 10. In this case, if there are a plurality of temperature limit values stored in the storage device 22, the control device 23 may, for example, select and use one of the plurality of temperature limit values according to a current output value (i.e., a discharging of electric power) of the battery pack 1. Taking Table 1 as an example, the control device 23 may perform the protection operation using a value of 70° C. as the temperature limit value if the output of the battery pack 1 is less than or equal to 1000 W, the control device 23 may perform the protection operation using a value of 60° C. as the temperature limit value if the output of the battery pack 1 is greater than 1000 W and less than or equal to 1800 W, and the control device 23 may perform the protection operation using a value of 65° C. as the temperature limit value if the output of the battery pack 1 is greater than 1800 W and less than or equal to 2000 W.

The control device 23 may monitor a temperature value measured after the protection operation is performed and an output value of the battery pack 1 at a time when the protection operation is performed, and may update or add the temperature limit value based on the monitored values. The battery module 10 may maintain temperature rise for a predetermined period of time due to residual heat even after the protection operation is performed. The control device 23 may continuously detect the temperature of the battery module 10 to check how much the temperature of the battery module 10 rises after the protection operation is performed. The control device 23 may determine whether the temperature limit value is updated by comparing the temperature value measured after the protection operation is performed with a predetermined maximum allowable temperature value. The control device 23 may determine a maximum temperature value among temperature values detected after the protection operation is performed, and may compare the maximum temperature value with the predetermined maximum allowable temperature value to check whether the temperature value after the protection operation is higher than the maximum allowable temperature value. The control device 23 may continuously measure the temperature value of the battery module 10 after the protection operation is performed, and may compare the measured temperature value with the maximum allowable temperature value each time the temperature value is obtained to check whether the temperature value after the protection operation is higher than the maximum allowable temperature value. The control device 23 may measure the temperature value of the battery module 10 after a predetermined time from a time when the protection operation is performed, and may compare the measured temperature value with the maximum allowable temperature value to check whether the temperature value after the protection operation is higher than the maximum allowable temperature value.

If the temperature value of the battery module 10 measured after the protection operation is higher than the maximum allowable temperature value, the control device 23 may, for example, update the temperature limit value used, e.g., lower the temperature limit value or otherwise correcting it, when the protection operation is performed by a predetermined value (e.g., 3° C.). Then, the control device 23 may change the temperature limit value stored in the storage device 22 using the corrected temperature limit value. For example, if the temperature value of the battery module 10 detected after the protection operation is performed is 95° C., that value is higher than the maximum allowable temperature value of 85° C. in a state where the output value of the battery pack 1 is 2000 W and the temperature limit value corresponding to 2000 W is set to 70° C., the control device 23 may correct the temperature limit value to be 67° C. Then, the control device 23 may update the temperature limit value stored in the storage device 22 corresponding to 2000 W to be 67° C.

If the temperature limit value corresponding to the current output value of the battery pack 1 is not stored in the storage device 22, the control device 23 may perform the protection operation using the temperature limit value set by default. For example, if the battery pack 1 operates with an output of 1800 W in a state where only the temperature limit value set based on an output of 2000 W is stored in the storage device 22, the control device 23 may perform the protection operation using 70° C. that is a default value of the temperature limit value.

After the protection operation is performed using the default value of the temperature limit value, the control device 23 may add the temperature limit value corresponding to the output value of the battery pack 1 to the storage device 22 according to a result of comparing the temperature value of the battery module 10 after the protection operation is performed with the maximum allowable temperature value. If the temperature value of the battery module 10 detected after the protection operation is performed is greater than the maximum allowable temperature value, the control device 23 may correct the temperature limit value by lowering the temperature limit value used when the protection operation is performed by a predetermined value (e.g., lowering by about 3° C.). Then, the control device 23 may map the corrected temperature limit value to the output value when the protection operation of the battery pack 1 is performed to additionally store (or register) the corrected temperature limit value in the storage device 22. If the temperature value of the battery module 10 detected after the protection operation is performed is less than or equal to the maximum allowable temperature value, the control device 23 may map the temperature limit value used when the protection operation is performed to the output value when the protection operation of the battery pack 1 is performed to additionally store the temperature limit value used when the protection operation is performed in the storage device 22. For example, if the temperature value of the battery module 10 detected after the protection operation is 89° C., that temperature value is higher than the maximum allowable temperature value of 85° C. in a state where the output value of the battery pack 1 is 1800 W and the temperature limit value used when the protection operation is performed is the default value of 70° C., the control device 23 may correct the temperature limit value to be 67° C. Then, the control device 23 may map the corrected temperature limit (67° C.) to the output value of 1800 W to add the corrected temperature limit (67° C.) to the storage device 22. For example, if the temperature value of the battery module 10 detected after the protection operation is 83° C., that temperature value is lower than the maximum allowable temperature value of 85° C. in a state where the output value of the battery pack 1 is 1000 W and the temperature limit value used when the protection operation is performed is the default value of 70° C., the control device 23 may map the temperature limit (70° C.) used when the protection operation is performed to the output value of 1000 W to add the temperature limit (70° C.) used when the protection operation is performed to the storage device 22.

The control device 23 may be implemented by a battery management system (BMS) of the battery pack 1, and may include at least one processor to perform the above-described functions.

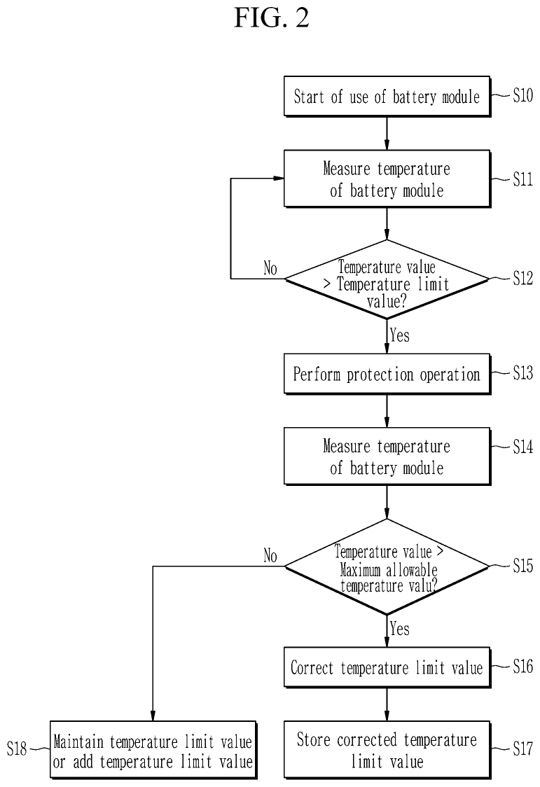

Hereinafter, referring to FIG. 2, a protection method of the battery pack 1 according to an embodiment is described in detail.

FIG. 2 is a flow diagram for one example of the protection method of the battery pack 1 according to the embodiment. The method of FIG. 2 may be performed by the control device 23 described with reference to FIG. 1.

Referring to FIG. 2, if a use of the battery module 10 begins (i.e., if discharging begins) (S10), the control device 23 may obtain the temperature value by continuously measuring the temperature of the battery module 10 through the temperature sensor 211 (S11). The control device 23 may compare the measured temperature value with the temperature limit value to check whether the temperature value is greater than the temperature limit value (inquiry_S12).

In the step S12, the temperature limit value may be selected according to the current output value of the battery pack 1. If the temperature limit value corresponding to the current output value of the battery pack 1 is already stored in the storage device 22, the control device 23 may select the stored temperature limit value to compare the selected temperature limit value with the measured temperature value. If the temperature limit value corresponding to the current output value of the battery pack 1 is not yet stored in the storage device 22 (a “No” to inquiry S12), the control device 23 may, for example, select the temperature limit value set by default to compare the selected temperature limit value with the measured temperature value.

If the measured temperature value is greater than the temperature limit value (a “Yes” to inquiry S12), the control device 23 may perform the protection operation (S13). That is, the control device 23 may block a current path between output terminals of the battery pack 1 and the battery module 10 to block charging and discharging of the battery pack 1.

The control device 23 may obtain the temperature value by continuously measuring the temperature of the battery module 10 through the measurement device 21 even after the protection operation is performed (S14). The control device 23 may compare the measured temperature value with a predetermined maximum allowable temperature value to check whether the temperature value of the battery module 10 measured after the protection operation is higher than the maximum allowable temperature value (inquiry_S15).

In the inquiry S15, the control device 23 may select a maximum temperature value among temperature values measured after the protection operation is performed, and may compare the selected temperature value with the maximum allowable temperature value to check whether the temperature value after the protection operation is higher than the maximum allowable temperature value. Every time the temperature value of the battery module 10 is obtained after the protection operation is performed, the control device 23 may, for example, compare the obtained temperature value with the maximum allowable temperature value to check whether the temperature value after the protection operation is higher than the maximum allowable temperature value. The control device 23 may measure the temperature value of the battery module 10 after a predetermined time from a time when the protection operation is performed, and may compare the measured temperature value with the maximum allowable temperature value to check whether the temperature value after the protection operation is higher than the maximum allowable temperature value.

If the temperature value of the battery module 10 measured after the protection operation is higher than the maximum allowable temperature value, the control device 23 may update the temperature limit value used, e.g., lowering the temperature limit value or otherwise correcting it, when the protection operation is performed by a predetermined value (S16). Then, the control device 23 may store the corrected temperature limit value in the storage device 22 (S17). In the step S17, if the corrected temperature limit value is stored, the control device 23 may store the corrected temperature limit value corresponding to the output value of the battery pack 1 at a time when the protection operation is performed. If the temperature limit value corresponding to the output value already exists, the control device 23 may change a previously stored temperature limit value to the temperature limit value corrected through the step S16 to store the changed temperature limit value. If the temperature limit value corresponding to the output value is not yet stored in the storage device 22, the control device 23 may map the output value to the temperature limit value corrected through the step S16 to additionally store (or register) the corrected temperature limit value in the storage device 22.

If the temperature value of the battery module 10 measured after the protection operation is less than or equal to the maximum allowable temperature value (a “No” to inquiry S15), the control device 23 may maintain a previously stored temperature limit value stored in the storage device 22 or may add a new temperature limit value to the storage device 22 (S18).

In the step S18, if the temperature limit value corresponding to the output value of the battery pack 1 at a time when the protection operation is performed is already stored in the storage device 22, the control device 23 may maintain an original value without changing the temperature limit value. If the temperature limit value corresponding to the output value of the battery pack 1 at the time when the protection operation is performed is not yet set, the control device 23 may map the temperature limit value (the default value) used in the step S12 to the output value of the battery pack 1 to additionally store the temperature limit value in the storage device 22.

According to the embodiment described above, through learning, the protection device 20 may correct the temperature limit value to suit the output value of the battery pack 1 or may add a new temperature limit value. Therefore, deterioration or damage of the battery pack 1 due to residual heat after the protection operation is performed may be minimized, and safety of the battery pack 1 may be improved and/or maximized.

Electronic or electrical devices according to embodiments of the present disclosure and/or other related devices or constituent elements may be realized by using appropriate hardware, firmware (e.g., an application-specific integrated circuit), software, or combinations of software, firmware, and hardware. For example, various configurations of the above-noted devices may be disposed on one or more integrated circuit (IC) chips or an individual IC chip. For example, where the devices are disposed on one IC, it may be, for example, a System-On-Chip or “SOC.” In some embodiments, various configurations of the above-noted devices may be realized on a flexible printed circuit film, a tape carrier package (TCP), a printed circuit board (PCB), or one substrate. The electrical or mutual connections described in the present specification may, for example, be realized by the PCB, wires on different types of circuit carriers, or conductive elements. The conductive elements may, for example, include metallization such as surface metallizations and/or pins, and may include, for example, conductive polymers or ceramics.

In an example, the various configurations of the devices may be performed by at least one processor so as to perform the above-described various functions. One or more of these various configurations may be performed in at least one computing device, and they may be, for example, processes or threads for performing computer program instructions and interacting with other system constituent elements. The computer program instructions may be stored, for example, in a memory of a computing device using a standard memory device such as, for example, a random access memory (RAM) or other types of volatile or non-volatile memory. The computer program instruction may also be stored in a non-transitory computer readable medium such as, for example, a CD-ROM, a flash drive or other solid state storage device, a disk drive or the like.

Further, a person of ordinary skill in the art must understand that various functions of the computing device may be combined or united to a single computing device, or functions of a specific computing device may be dispersed to at least another computing device while not digressing from the range of the embodiments of the present disclosure.

A problem to be solved through the present disclosure is to provide a protection method of a battery pack that may provide an appropriate temperature protection function according to an output of a battery pack, and is to provide a protection device and a battery pack that perform the protection method of the battery pack.

A protection device for a battery pack including a battery module according to embodiments for solving the above problem includes, for example: a temperature sensor that may be configured to measure a temperature of the battery module; and a control device that may be configured to perform a protection operation of the battery pack if a first temperature value measured through the temperature sensor during a use of the battery module is greater than a first temperature limit value and to correct the first temperature limit value according to a second temperature value measured through the temperature sensor after the protection operation is performed.

The protection device may further include, for example, a storage device that may be configured to store at least one temperature limit value corresponding to at least one output value of the battery pack.

The control device may select the first temperature limit value according to the output value of the battery pack.

If the battery pack outputs a first output value and the temperature limit value corresponding to the first output value is already stored in the storage device, the control device may use the temperature limit value corresponding to the first output value as the first temperature limit value.

If the battery pack outputs a second output value that is different from the first output value and the temperature limit value corresponding to the second output value is already stored in the storage device, the control device may use the temperature limit value corresponding to the second output value as the first temperature limit value.

If the battery pack outputs a third output value and the temperature limit value corresponding to the third output value is not stored in the storage device, the control device may use a predetermined default value as the first temperature limit value.

If the second temperature value is greater than a maximum allowable temperature value, the control device may correct the first temperature limit value to be reduced by a predetermined value.

If the second temperature value is less than or equal to a maximum allowable temperature value, the control device may maintain the first temperature limit value.

If the protection operation is performed while the battery pack discharges to a first output value and a temperature limit value corresponding to the first output value is not stored, the control device may register the first temperature limit value as the temperature limit value corresponding to the first output value.

A battery pack according to embodiments includes: a battery module; and the protection device.

A protection method of the battery pack according to embodiments includes, for example: measuring a first temperature value of a battery module included in the battery pack while the battery pack discharges; performing a protection operation of the battery pack if the first temperature value is greater than a first temperature limit value; measuring a second temperature value of the battery module after the protection operation is performed; and correcting the first temperature limit value according to the second temperature value.

The protection method may further include selecting the first temperature limit value according to an output value of the battery pack.

The selecting of the first temperature limit value may include selecting an already stored temperature limit value corresponding to a first output value as the first temperature limit value if the battery pack outputs the first output value and a temperature limit value corresponding to the first output value is already stored.

The selecting of the first temperature limit value may include selecting an already stored temperature limit value corresponding to a second output value as the first temperature limit value if the battery pack outputs the second output value different from the first output value and a temperature limit value corresponding to the second output value is already stored.

The selecting of the first temperature limit value may include selecting a default value as the first temperature limit value if the battery pack outputs a third output value and a temperature limit value corresponding to the third output value is not stored.

The correcting of the first temperature limit value may include correcting the first temperature limit value to be reduced by a predetermined value if the second temperature value is greater than a maximum allowable temperature value.

The correcting of the first temperature limit value may include maintaining the first temperature limit value if the second temperature value is less than or equal to a maximum allowable temperature value.

The protection method may further include, for example, registering the first temperature limit value as a temperature limit value corresponding to a first output value if the protection operation is performed while the battery pack discharges to the first output value and the temperature limit value corresponding to the first output value is not registered.

According to the present disclosure, even if an output of a battery pack changes, damage to the battery pack due to overheating may be prevented by performing a temperature protection operation according to the changed output.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A protection device for a battery pack including a battery module, the protection device comprising:
a temperature sensor configured to measure a temperature of the battery module; and
a controller configured to perform a protection operation of the battery pack if a first temperature value measured through the temperature sensor during a use of the battery module is greater than a first temperature limit value and to correct the first temperature limit value according to a second temperature value measured through the temperature sensor after the protection operation is performed.

2. The protection device as claimed in claim 1, further comprising a storage device configured to store at least one temperature limit value corresponding to at least one output value of the battery pack.

3. The protection device as claimed in claim 2, wherein the controller is further configured to select the first temperature limit value according to the output value of the battery pack.

4. The protection device as claimed in claim 3, wherein if the battery pack outputs a first output value and the temperature limit value corresponding to the first output value is already stored in the storage device, the controller is further configured to use the temperature limit value corresponding to the first output value as the first temperature limit value.

5. The protection device as claimed in claim 4, wherein if the battery pack outputs a second output value that is different from the first output value and the temperature limit value corresponding to the second output value is already stored in the storage device, the controller is further configured to use the temperature limit value corresponding to the second output value as the first temperature limit value.

6. The protection device as claimed in claim 4, wherein if the battery pack outputs a third output value and the temperature limit value corresponding to the third output value is not stored in the storage device, the controller is further configured to use a predetermined default value as the first temperature limit value.

7. The protection device as claimed in claim 1, wherein if the second temperature value is greater than a maximum allowable temperature value, the controller is further configured to correct the first temperature limit value to be reduced by a predetermined value.

8. The protection device as claimed in claim 1, wherein if the second temperature value is less than or equal to a maximum allowable temperature value, the controller is further configured to maintain the first temperature limit value.

9. The protection device as claimed in claim 2, wherein if the protection operation is performed while the battery pack discharges to a first output value and a temperature limit value corresponding to the first output value is not stored in the storage device, the controller is further configured to store the first temperature limit value in the storage device as the temperature limit value corresponding to the first output value.

10. A battery pack comprising:
a battery module; and
a protection device for a battery pack including a battery module, comprising:
a temperature sensor configured to measure a temperature of the battery module; and
a controller configured to perform a protection operation of the battery pack if a first temperature value measured through the temperature sensor during a use of the battery module is greater than a first temperature limit value and to correct the first temperature limit value according to a second temperature value measured through the temperature sensor after the protection operation is performed.

11. A protection method for a battery pack, the method comprising:
measuring a first temperature value of a battery module included in the battery pack while the battery pack discharges;
performing a protection operation of the battery pack if the first temperature value is greater than a first temperature limit value;
measuring a second temperature value of the battery module after the protection operation is performed; and
correcting the first temperature limit value according to the second temperature value.

12. The protection method as claimed in claim 11, further comprising selecting the first temperature limit value according to an output value of the battery pack.

13. The protection method as claimed in claim 12, wherein the selecting of the first temperature limit value includes selecting an already stored temperature limit value corresponding to a first output value as the first temperature limit value if the battery pack outputs the first output value and a temperature limit value corresponding to the first output value is already stored.

14. The protection method as claimed in claim 13, wherein the selecting of the first temperature limit value includes selecting an already stored temperature limit value corresponding to a second output value as the first temperature limit value if the battery pack outputs the second output value different from the first output value and a temperature limit value corresponding to the second output value is already stored.

15. The protection method as claimed in claim 13, wherein the selecting of the first temperature limit value includes selecting a default value as the first temperature limit value if the battery pack outputs a third output value and a temperature limit value corresponding to the third output value is not stored.

16. The protection method as claimed in claim 11, wherein the correcting of the first temperature limit value includes correcting the first temperature limit value to be reduced by a predetermined value if the second temperature value is greater than a maximum allowable temperature value.

17. The protection method as claimed in claim 11, wherein the correcting of the first temperature limit value includes maintaining the first temperature limit value if the second temperature value is less than or equal to a maximum allowable temperature value.

18. The protection method as claimed in claim 11, further comprising registering the first temperature limit value as a temperature limit value corresponding to a first output value if the protection operation is performed while the battery pack discharges to the first output value and the temperature limit value corresponding to the first output value is not registered.
